(19) United States
(12) Patent Application Publication
(10) Pub. No.: US 2008/0030858 A1
(43) Pub. Date: Feb. 7, 2008

(54) Optical filter and optical apparatus

(76) Inventor: Yorio Wada, Hanno-shi (JP)

Correspondence Address: KENYON & KENYON LLP, ONE BROADWAY, NEW YORK, NY, 10004, US

(21) Appl. No.: 11/787,065

(22) Filed: Apr. 13, 2007

(30) Foreign Application Priority Data
May 12, 2005 (JP) 2005-139745

(51) Int. Cl. G02B 1/11

(52) U.S. Cl. 359/588

(57) ABSTRACT

An optical filter has a transmission band for transmitting light with a predetermined wavelength, including: a substrate; and a thin film where layers with comparatively high refractive indexes and layers with comparatively low refractive indexes are alternately laminated, in which one side of the thin film is in contact with the substrate and the other side of the thin film is in contact with an incident medium, in which the thin film includes: a first lamination portion where refractive indexes of the high refractive index layers gradually become higher from the incident medium side to the substrate side; a second lamination portion, adjacent to the first lamination portion, where refractive indexes of the high refractive index layers are substantially the same as that of a maximum refractive index layer of the first lamination portion; and a third lamination portion, adjacent to the second lamination portion, where refractive indexes of the high refractive index layers gradually become lower from the third lamination portion side to the substrate side, and in which an anti-reflective film for preventing reflection, in the transmission band, of light incident into the thin film is placed between the incident medium and the first lamination portion.

### BACKGROUND OF THE INVENTION

1. Field of the Invention

The present invention relates to an optical filter and an optical apparatus.

2. Description of Related Art

Optical apparatuses used for observation of biological specimens or the like include fluorescence microscopes. In fluorescence microscopes, the structure and characteristics of a specimen can be analyzed by observing fluorescence emitted by the specimen. At this time, the specimen (cell(s)) is dyed. Irradiation of exciting light onto the specimen causes fluorescence to be emanated from the specimen. In recent genomic analysis, for example, there is a need for irradiation of exciting light including a wavelength of 502 nm onto a specimen to observe fluorescence having a peak at 526 nm. In this case, it is necessary to efficiently detect only the fluorescence since the exciting light and the fluorescence have neighboring wavelengths. As a result, it is required for the optical filter to have a characteristic of securely cutting off the exciting light and of efficiently passing through the light with a fluorescence observation wavelength. That is, such an optical filter is a very important part for determining the sensitivity and precision of fluorescence measurements.

It is required for this optical filter to have a steep rise on a border between a transmission band that transmits light in a desired wavelength band (hereinafter, referred to simply as a transmission band) and a rejection band that rejects light in a predetermined wavelength band (hereinafter, referred to simply as a rejection band) and to have a capability of transmitting substantially 100% light in the transmission band. Furthermore, it is preferable that this optical filter have no periodical variation (ripple) of transmittance with respect to an increase/decrease in wavelength in the transmission band.

An optical filter that cuts off light in a predetermined wavelength band and transmits light in other wavelength bands as described above is called a minus filter. The minus filter is provided with a multiple-layered film in which films with a high refractive index and films with a low refractive index are alternately laminated.

Japanese Unexamined Patent Publication, First Publication No. 2004-310008 proposes an optical filter with a configuration that makes a rise of the transmission band steep and generates no ripple. In this optical filter, an incident medium on the incident light side and a substrate are composed of materials with the same refractive index. Furthermore, in this optical filter, a multiple-layered film is sandwiched between these.

However, in conventional optical filters, glass or the like is used for an incident material on the incident light side. As a result, in the case where light is incident diagonally into the filter, there is the problem such as that the optical axis of the reflected light is displaced with respect to that of the incident light. To avoid such a problem, it is generally preferable that the incident medium be air.

FIG. 7A shows a refractive index profile of an optical filter. With this refractive index profile, letting the incident medium be air (n=1.0), ripples are generated in the transmission band to decrease the transmittance, as shown in FIG. 7B. To suppress these ripples to increase the transmittance, it is necessary to change the thickness of each layer of the optical filter. However, in this case, controllability of film thickness becomes poor, resulting in difficulty in forming a layer having a stable optical characteristic.

### SUMMARY OF THE INVENTION

The present invention has been achieved in view of the above circumstances, and has an object to provide an optical filter that has reduced ripples while keeping controllability of the thickness of each layer, and an optical apparatus provided with the same.

To solve the above problem, the present invention adopts the following configuration.

An optical filter according to the present invention is an optical filter that has a transmission band for transmitting light with a predetermined wavelength, including: a substrate; and a thin film where layers with comparatively high refractive indexes and layers with comparatively low refractive indexes are alternately laminated, in which one side of the thin film is in contact with the substrate and the other side of the thin film is in contact with an incident medium, in which the thin film includes: a first lamination portion where refractive indexes of the high refractive index layers gradually become higher from the incident medium side to the substrate side; a second lamination portion, adjacent to the first lamination portion, where refractive indexes of the high refractive index layers are substantially the same as that of a maximum refractive index layer of the first lamination portion; and a third lamination portion, adjacent to the second lamination portion, where refractive indexes of the high refractive index layers gradually become lower from the third lamination portion side to the substrate side, and in which

an anti-reflective film for preventing reflection, in the transmission band, of light incident into the thin film is placed between the incident medium and the first lamination portion.

Another optical filter according to the present invention is an optical filter that has a transmission band for transmitting light with a predetermined wavelength, including: a substrate; and a thin film where layers with comparatively high refractive indexes and layers with comparatively low refractive indexes are alternately laminated, in which one side of the thin film is in contact with the substrate and the other side of the thin film is in contact with an incident medium, in which the thin film includes: a first lamination portion where refractive indexes of the low refractive index layers gradually become lower from the incident medium side to the substrate side; a second lamination portion, adjacent to the first lamination portion, where refractive indexes of the low refractive index layers are substantially the same as that of a minimum refractive index layer of the first lamination portion; and a third lamination portion, adjacent to the second lamination portion, where refractive indexes of the low refractive index layers gradually become higher from the third lamination portion side to the substrate side, and in which an anti-reflective film for preventing reflection, in the transmission band, of light incident into the thin film is placed between the incident medium and the first lamination portion.

Preferably, an optical filter according to the present invention is the above-mentioned optical filter, in which the anti-reflective film has low refractive index layers with comparatively low refractive indexes and high refractive index layers with comparatively high refractive indexes are alternately laminated, with optical film thicknesses thereof being mutually different.

Preferably, an optical filter according to the present invention is the above-mentioned optical filter, in which the anti-reflective film includes: a layer having substantially the same refractive index as a minimum refractive index among those in the first lamination portion, in the second lamination portion, and in the third lamination portion; a layer having substantially the same refractive index as a maximum refractive index among those in the three lamination portions; and a layer having an intermediate refractive index of the two indexes.

Preferably, an optical filter according to the present invention is the above-mentioned optical filter, in which a topmost layer of the anti-reflective film is of magnesium fluoride.

Preferably, an optical filter according to the present invention is the above-mentioned optical filter, in which the anti-reflective film is made of three or more laminated layers of the high refractive index layer and the low refractive index layer.

Preferably, an optical filter according to the present invention is the above-mentioned optical filter, in which the anti-reflective film is configured to have an optical characteristic corresponding to an average refractive index of the thin film so as to prevent reflection.

Preferably, an optical apparatus according to the present invention includes an optical filter according to the present invention.

### BRIEF DESCRIPTION OF THE DRAWINGS

FIG. 1 shows a configuration of a fluorescence microscope according to the present invention.

FIG. 2A is a graph showing a film configuration of an optical filter of a first embodiment according to the present invention.

FIG. 2B is a graph showing a spectral characteristic of the optical filter of the first embodiment according to the present invention.

FIG. 3A is a graph showing a film configuration of an optical filter of a second embodiment according to the present invention.

FIG. 3B is a graph showing a spectral characteristic of the optical filter of the second embodiment according to the present invention.

FIG. 4A is a graph showing a film configuration of an optical filter of a third embodiment according to the present invention.

FIG. 4B is a graph showing a spectral characteristic of the optical filter of the third embodiment according to the present invention.

FIG. 5A is a graph showing a film configuration of an optical filter of a fourth embodiment according to the present invention.

FIG. 5B is a graph showing a spectral characteristic of the optical filter of the fourth embodiment according to the present invention.

FIG. 6A is a graph showing a film configuration of an optical filter of a fifth embodiment according to the present invention.

FIG. 6B is a graph showing a spectral characteristic of the optical filter of the fifth embodiment according to the present invention.

FIG. 7A is a graph showing a film configuration of a conventional optical filter.

FIG. 7B is a graph showing a spectral characteristic of the conventional optical filter.

### DETAILED DESCRIPTION OF THE INVENTION

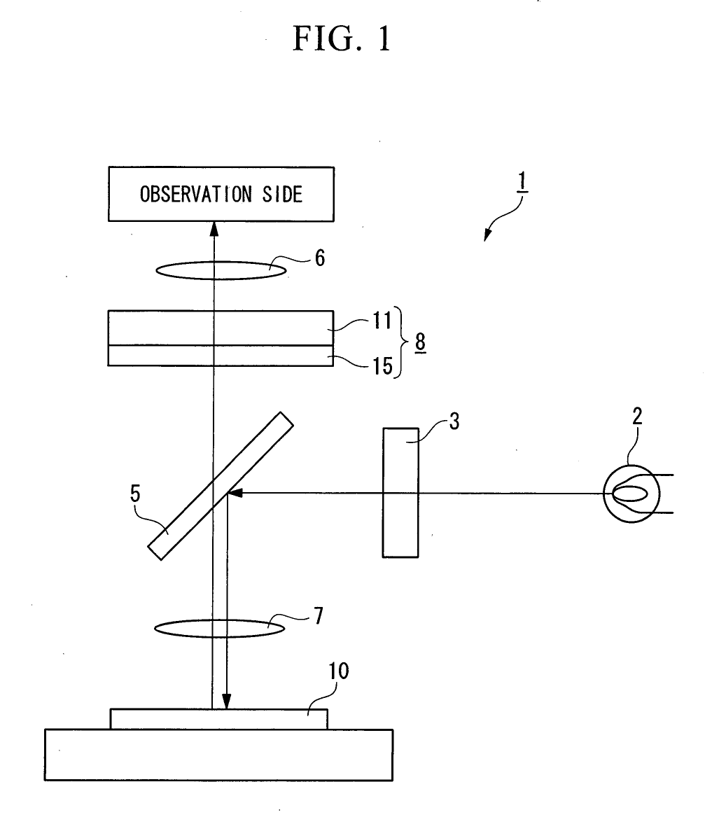

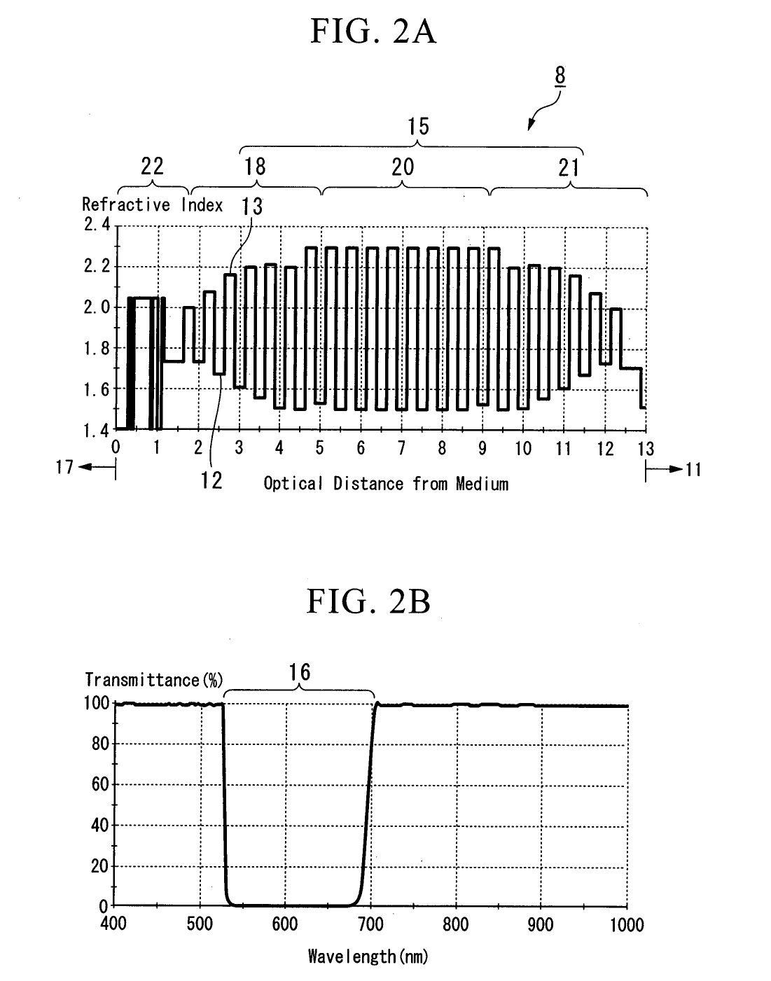

An embodiment according to a first embodiment of the present invention will be described with reference to FIG. 1 and FIGS. 2A and 2B.

FIG. 1 shows a fluorescence microscope (an optical apparatus) in which an optical filter according to the present invention is used. The fluorescence microscope 1 includes: a light source 2; an excitation filter 3; a dichroic mirror 5; an eyepiece lens 6 and an objective lens 7; and an absorption filter (an optical filter) 8, as shown in FIG. 1.

The excitation filter 3 is arranged in an optical path of the light source 2. The excitation filter 3 selectively transmits specific wavelengths, of the light generated from the light source 3, as exciting light.

The dichroic mirror 5 is arranged in an optical path of the light having passed through the excitation filter 3 (hereinafter, referred to as exciting light). The dichroic mirror 5 irradiates the exciting light onto a specimen 10 such as a biological cell. It also has an optical characteristic of transmitting the fluorescence that has been emanated from the specimen 10 by the exciting light to the observation side. Instead of the dichroic mirror 5, a half mirror may be used. The eyepiece lens 6 and the objective lens 7 are arranged such that the fluorescence is observed.

The absorption filter 8 is an optical filter. It has a substrate 11 and a thin film 15. The thin film 15 is composed of low refractive index layers 12 with relatively low refractive indexes and high refractive index layers 13 with relatively high refractive indexes. In the thin film 15, these two types of layers are alternately laminated on the substrate 11. With this configuration, in the absorption filter 8, one side of the thin film 15 having a transmission band 16 for transmitting light in a predetermined wavelength region is in contact with the substrate 11, and the other side of the thin film 15 is in contact with an incident medium, which is air here. As shown in FIG. 2A, the thin film 15 includes a first lamination portion 18, a second lamination portion 20, and a third lamination portion 21. In the first lamination portion 18, the refractive indexes of the high refractive index layers 13 gradually become higher from the incident medium 17 side to the substrate 11 side. Furthermore, the refractive indexes of the low refractive index layers 12 gradually become lower. The second lamination portion 20 is adjacent to the first lamination portion 18. In the second lamination portion 20, the refractive indexes of the high refractive index layers 13 are substantially the same as the highest refractive index among those in the high refractive index layers 13 that compose the first lamination portion 18. Furthermore, the refractive indexes of the low refractive index layers 12 are substantially the same as the lowest refractive index among those in the low refractive index layers 12 that compose the first lamination portion 18. The third lamination portion 21 is adjacent to the second lamination portion 20. In the third lamination portion 21, the refractive indexes of the high refractive index layers 13 gradually become lower toward the substrate 11 side, and the refractive indexes of the low refractive index layers 12 gradually become higher. Between the incident medium 17 and the first lamination portion 18, there is provided an anti-reflective film 22. The anti-reflective film 22 prevents reflection of the light incident into the thin film 15 in the light transmission band. “Substantially the same refractive index” means that the refractive indexes are identical or that the difference in refractive index is in the range of 0.2 or less.

The low refractive index layer 12 is mainly composed of silicon oxide. The high refractive index layer 13 is mainly composed of titanium oxide. In the present embodiment, the refractive index of the substrate 11 is 1.50. The incident medium 17 has a refractive index of 1.0, since it is air. The refractive indexes of the high refractive index layers 13 are changed from 2.0 to 2.3. The refractive indexes of the low refractive index layers 12 are changed from 1.5 to 1.8. In this case, the thin film 15 has an average refractive index of 1.9.

The design wavelength of the absorption filter 8 is λ=600 nm. The optical film thickness of each of the refractive index layers in the first lamination portion 18, the second lamination portion 20, and the third lamination portion 21 is 0.25λ (with the exception that the optical film thickness of the layer that is adjacent to the incident medium 17 of the first lamination portion 18 and the optical film thickness of the layer that is adjacent to the substrate 11 of the third lamination portion 21 are 0.5λ).

The anti-reflective film 22 is composed of a plurality of layers. The individual layers have mutually different optical film thicknesses and refractive indexes. In the present embodiment, eight layers are laminated. The refractive indexes and optical film thicknesses of the individual layers are, in order from the layer on the incident medium 17 side: n=1.38 (optical film thickness: 159 nm), n=2.07 (58 nm), n=1.38 (34 nm), n=2.07 (242 nm), n=1.38 (26 nm), n=2.07 (76 nm), n=1.38 (54 nm), and n=2.07 (40 nm).

The thin film 15 as a whole has 53 layers, inclusive of the anti-reflective film 22.

With the absorption filter 8, ripples in the transmission band can be suppressed to equal or below ±0.2% while sufficiently securing a sufficient region of a rejection band. That is, transmittance in the transmission band can be 99% or more.

With the fluorescence microscope 1 provided with the optical filter 8, ripples in the transmission band (wavelength band of the fluorescence) can be reduced. Therefore, fluorescence detection sensitivity can be improved.

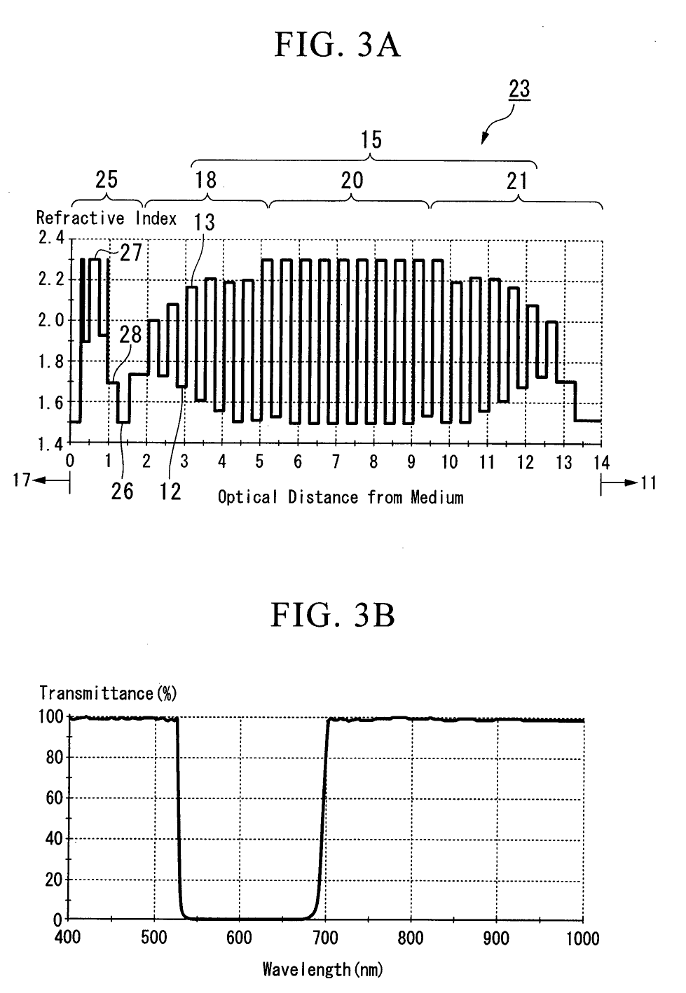

Next is a description of a second embodiment, with reference to FIGS. 3A and 3B.

Like constituent parts to the above-described first embodiment are designated with like reference numerals and are not repetitiously explained.

The difference between the second embodiment and the first embodiment lies in the configuration of an anti-reflective film 25 of an absorption filter 23 according to the present invention, as shown in FIG. 3A. The anti-reflective film 25 has layers 26, layers 27, and layers 28. The layer 26 has a refractive index that is substantially the same as the lowest refractive index among those in a first lamination portion 18, a second lamination portion 20, and a third lamination portion 21. The layer 27 has a refractive index that is substantially the same as the highest refractive index among those in the three lamination portions. The layer 28 has an intermediate refractive index between that of the layer 26 and that of the layer 27.

To be more specific, the number of the layers 27 is three. The refractive index of each layer is 2.3. The number of the layers 26 is two, the refractive index of which is 1.5. The number of the layers 28 is three. The refractive indexes of the respective layers are: 1.7, 1.9, and 1.93. In this manner, the anti-reflective film 25 has a configuration in which eight layers are laminated. The layer 28 having the intermediate refractive index is formed by mixing a high refractive index material and a low refractive index material.

The film configuration of the anti-reflective film 25 is as follows, in order from the incident medium 17 side: n=1.5 (optical film thickness: 161 nm), n=2.30 (35.2 nm), n=1.90 (83.6 nm), n=2.30 (160.8 m), n=1.93 (114.6 nm), n=2.3 (8.5 nm), n=1.7 (172.8 nm), and n=1.50 (189 nm).

The transmission characteristics when the design wavelength of the absorption filter 8 is set to be λ=600 nm is shown in FIG. 3B.

With the absorption filter 23, ripples in the transmission band can be suppressed to equal to or below ±0.2% while sufficiently securing a sufficient region of a rejection band. That is, transmittance in the transmission band can be 99% or more.

When the anti-reflective film 25 is manufactured, a high refractive index material and a low refractive index material may be used. For the film with an intermediate refractive index between the two, they may be mixed.

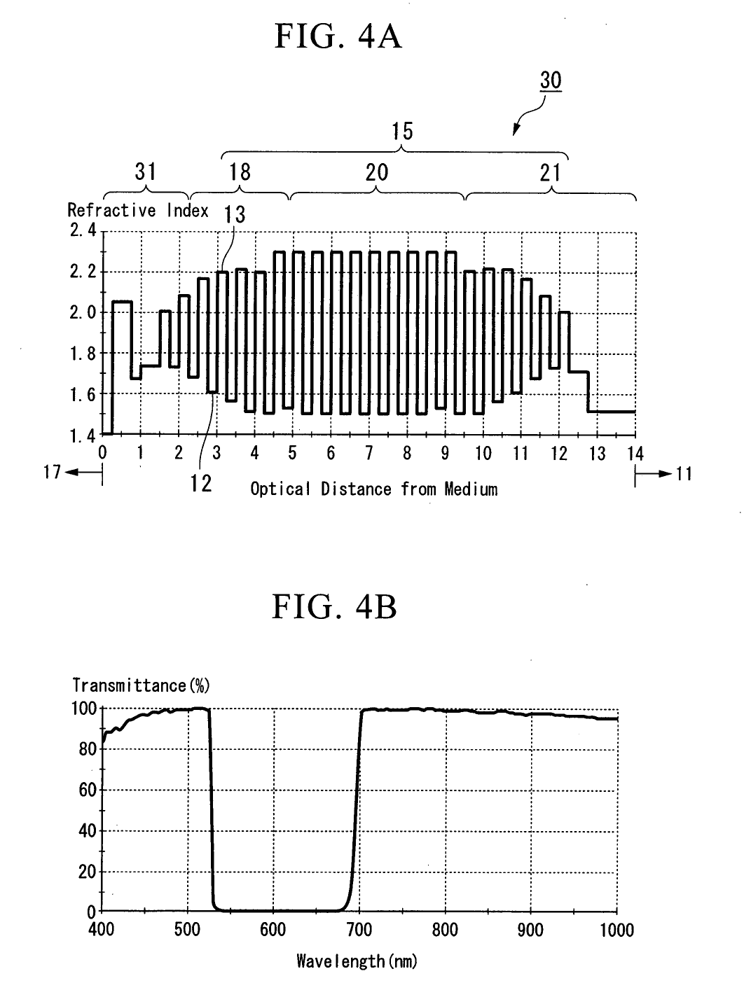

Next is a description of a third embodiment, with reference to FIGS. 4A and 4B.

Like constituent parts to the above-described another embodiment are designated with like reference numerals and are not repetitiously explained.

The difference between the third embodiment and the first embodiment lies in the configuration of an anti-reflective film 31 of an absorption filter 30. An anti-reflective film 31 includes: a topmost layer on an incident medium 17 side made of magnesium fluoride (MgF₂; optical film thickness 125 nm); a layer thereunder made of zirconium oxide (ZrO₂; 250 nm); and a layer further thereunder made of aluminum oxide (Al₂O₃; 125 nm). In this manner, the anti-reflective film 31 has a configuration in which three layers are laminated.

Also with the absorption filter 30, actions and effects similar to those of the another embodiment above can be obtained.

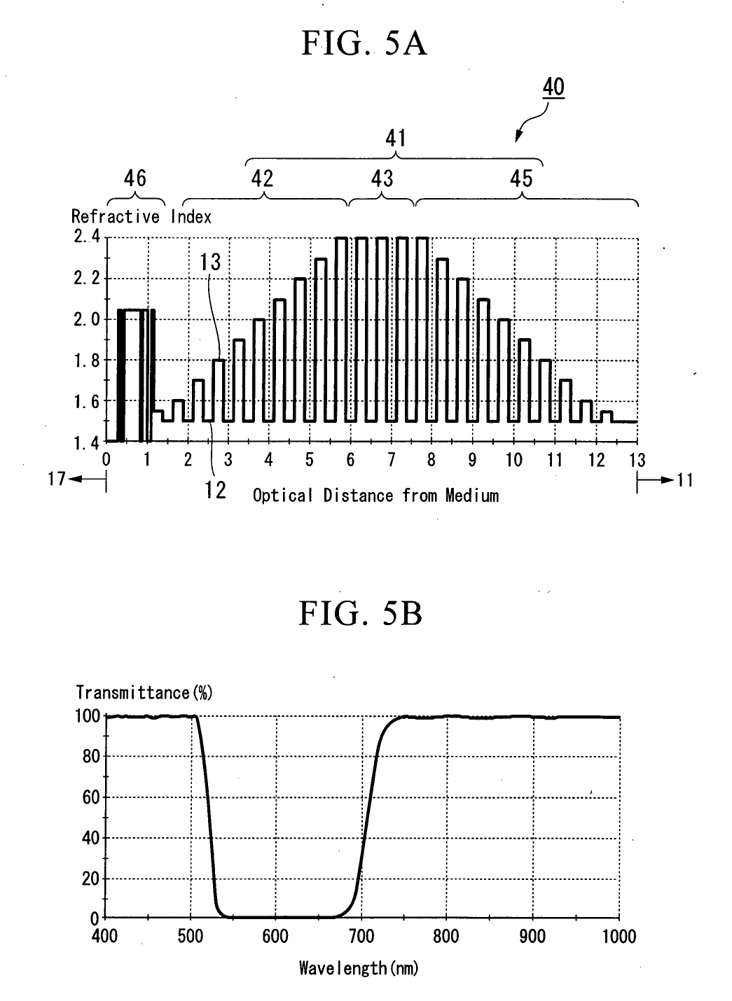

Next is a description of a fourth embodiment, with reference to FIGS. 5A and 5B.

Like constituent parts to the above-described other embodiments are designated with like reference numerals and are not repetitiously explained.

The difference between the fourth embodiment and the first embodiment lies in the configuration of a thin film 41 of an absorption filter 40 according to the present invention. In the thin film 41, the refractive indexes of high refractive index layers 13 of a first lamination portion 42 gradually become higher from 1.6 to 2.4, from an incident medium 17 side to a substrate 11 side. The refractive indexes of high refractive index layers 13 of a second lamination portion 43 are substantially the same as the highest refractive index among those of the high refractive index layers 13 of the first lamination portion 42. The refractive indexes of high refractive index layers 13 of a third lamination portion 45 gradually become lower from 2.4 to 1.55, toward the substrate 11 side. The refractive indexes of low refractive index layers of the individual lamination portions 42, 43, and 45 are 1.50, which is substantially the same as that of the substrate 11.

The design wavelength is λ=600 nm. The optical film thickness of each of the lamination portions 42, 43, and 45 is 0.25λ. This absorption filter 40 has 49 layers.

An anti-reflective film 46 is manufactured with an optical condition for preventing reflection with respect to an average refractive index (n=1.8) of those of the high refractive index layers 13 and those of the low refractive index layers 12 of the thin film 41. The film configuration (the number of layers) thereof is eight, which is the same as in the first embodiment.

Also with the absorption filter 40, actions and effects similar to those of the other embodiments above can be obtained.

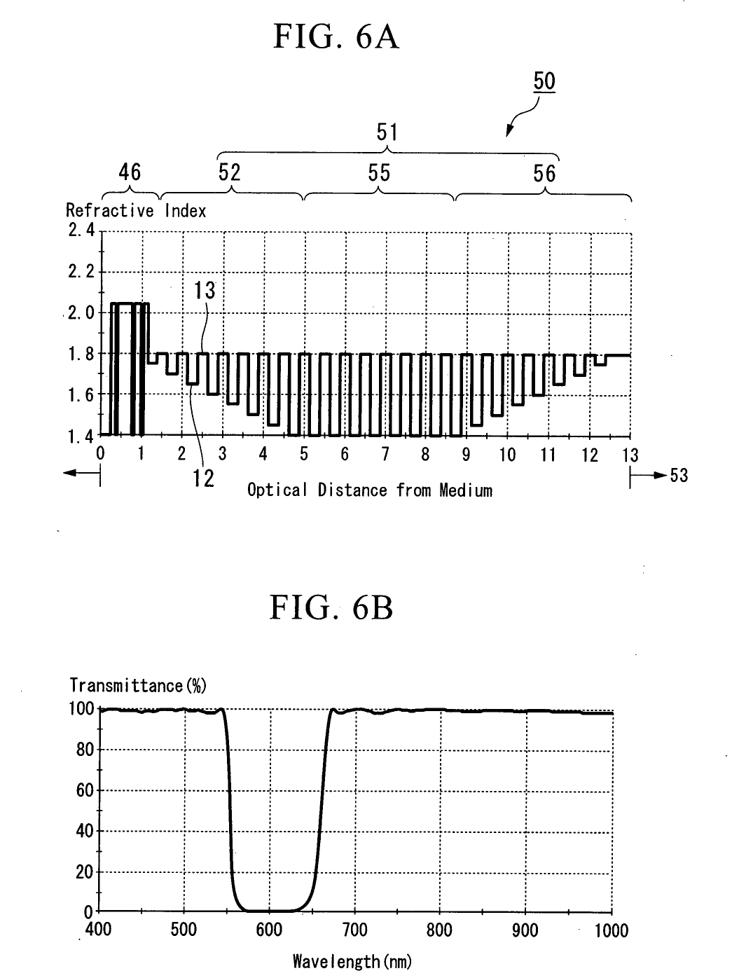

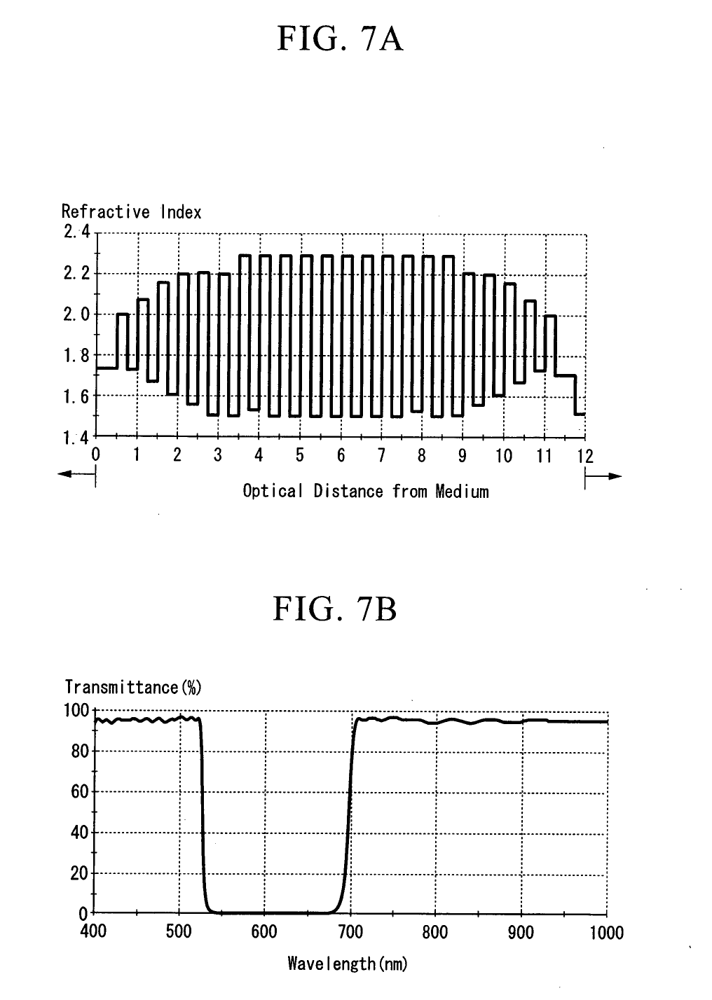

Next is a description of a fifth embodiment, with reference to FIGS. 6A and 6B.

Like constituent parts to the above-described other embodiments are designated with like reference numerals and are not repetitiously explained.

The difference between the fifth embodiment and the fourth embodiment lies in the configuration of a thin film 51 of an absorption filter 50 according to the present invention. In the thin film 51, the refractive indexes of low refractive index layers 12 of a first lamination portion 52 gradually become lower from 1.8 to 1.4, from an incident medium 17 side to a substrate 53 side. The refractive indexes of low refractive index layers 12 of a second lamination portion 55 are substantially the same as the lowest refractive index among those of the low refractive index layers 12 of the first lamination portion 52. The refractive indexes of low refractive index layers 12 of a third lamination portion 56 gradually become higher toward the substrate 53 side. The substrate 53 has a refractive index of 1.8. The refractive indexes of high refractive index layers 13 of the individual lamination portions 52, 55, and 56 are 1.8.

The design wavelength is λ=800 nm. The optical film thickness of each of the lamination portions 52, 55, and 56 is 0.25λ.

Also with the absorption filter 50, actions and effects similar to those of the other embodiments above can be obtained.

The scope of the art of the present invention is not limited to the above-described embodiments and various modifications can be made as long as they do not depart from the spirit or scope of this invention.

For example, in the above embodiments, the optical film thicknesses of the respective layers constituting the respective lamination portions are 0.25λ. However, an optical film thickness other than this may be used. Furthermore, the design wavelength is not limited to 600 nm or 800 nm.

While preferred embodiments of the invention have been described above, these are not to be considered as limitative of the invention. Addition, omission, and replacement of the constituents, and other modifications can be made without departing from the spirit or scope of the invention. The present invention is not limited by the descriptions above, but is limited only by the appended claims.

What is claimed is:

1. An optical filter that has a transmission band for transmitting light with a predetermined wavelength, comprising: a substrate; and a thin film where layers with comparatively high refractive indexes and layers with comparatively low refractive indexes are alternately laminated, wherein
one side of the thin film is in contact with the substrate and the other side of the thin film is in contact with an incident medium, wherein
the thin film comprises:
a first lamination portion where refractive indexes of the high refractive index layers gradually become higher from the incident medium side to the substrate side;
a second lamination portion, adjacent to the first lamination portion, where refractive indexes of the high refractive index layers are substantially the same as that of a maximum refractive index layer of the first lamination portion; and
a third lamination portion, adjacent to the second lamination portion, where refractive indexes of the high refractive index layers gradually become lower from the third lamination portion side to the substrate side, and wherein
an anti-reflective film for preventing reflection, in the transmission band, of light incident into the thin film is placed between the incident medium and the first lamination portion.

2. The optical filter according to claim 1, wherein the anti-reflective film is composed of laminated layers having mutually different optical film thicknesses and refractive indexes.

3. The optical filter according to claim 2, wherein the anti-reflective film comprises: a layer having substantially the same refractive index as a minimum refractive index among those in the first lamination portion, in the second lamination portion, and in the third lamination portion; a layer having substantially the same refractive index as a maximum refractive index among those in the three lamination portions; and a layer having an intermediate refractive index of the two indexes.

4. The optical filter according to claim 1, wherein a topmost layer of the anti-reflective film is of magnesium fluoride.

5. The optical filter according to claim 1, wherein the anti-reflective film is made of three or more laminated layers.

6. The optical filter according to claim 1, wherein the anti-reflective film is configured to have an optical characteristic corresponding to an average refractive index of the thin film so as to prevent reflection.

7. An optical apparatus comprising the optical filter according to claim 1.

8. An optical filter that has a transmission band for transmitting light with a predetermined wavelength, comprising: a substrate; and a thin film where layers with comparatively high refractive indexes and layers with comparatively low refractive indexes are alternately laminated, wherein
one side of the thin film is in contact with the substrate and the other side of the thin film is in contact with an incident medium, wherein
the thin film comprises:
a first lamination portion where refractive indexes of the low refractive index layers gradually become lower from the incident medium side to the substrate side;
a second lamination portion, adjacent to the first lamination portion, where refractive indexes of the low refractive index layers are substantially the same as that of a minimum refractive index layer of the first lamination portion; and
a third lamination portion, adjacent to the second lamination portion, where refractive indexes of the low refractive index layers gradually become higher from the third lamination portion side to the substrate side, and wherein
an anti-reflective film for preventing reflection, in the transmission band, of light incident into the thin film is placed between the incident medium and the first lamination portion.

9. The optical filter according to claim 8, wherein the anti-reflective film is composed of laminated layers having mutually different optical film thicknesses and refractive indexes.

10. The optical filter according to claim 9, wherein the anti-reflective film comprises: a layer having substantially the same refractive index as a minimum refractive index among those in the first lamination portion, in the second lamination portion, and in the third lamination portion; a layer having substantially the same refractive index as a maximum refractive index among those in the three lamination portions; and a layer having an intermediate refractive index of the two indexes.

11. The optical filter according to claim 8, wherein a topmost layer of the anti-reflective film is of magnesium fluoride.

12. The optical filter according to claim 8, wherein the anti-reflective film is made of three or more laminated layers.

13. The optical filter according to claim 8, wherein the anti-reflective film is configured to have an optical characteristic corresponding to an average refractive index of the thin film so as to prevent reflection.

14. An optical apparatus comprising the optical filter according to claim 8.
